(19) United States
(12) Patent Application Publication
(10) Pub. No.: US 2007/0165866 A1
(43) Pub. Date: Jul. 19, 2007

(54) METHOD AND APPARATUS TO FACILITATE CONVEYING AUDIO CONTENT

(75) Inventor: Boaz J. Super, Westchester, IL (US)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/275,545

(22) Filed: Jan. 13, 2006

(51) Int. Cl. H04R 5/00

(52) U.S. Cl. 381/1; 342/61

(57) ABSTRACT

These teachings provide a detector for determining a direction to a target, an audio emitter having a preferred directional output, and an audio receiver having a preferred directional sensitivity. The audio emitter and receiver are responsive to the directional information from the detector to maintain the target within their preferred directions.

### FIELD OF THE INVENTION

The present invention generally relates to audio communications.

### BACKGROUND OF THE INVENTION

Present audio communication systems include devices such as telephone handsets, wired or wireless headsets, speakerphones, megaphones, and public address speaker systems. Each of these present audio communication systems' present shortcomings relating to a user's freedom, comfort, or privacy.

For example, wired handsets and headsets require that a user be tethered to a base unit. Wireless handsets and cell phones require the user to carry and hold some apparatus. Wireless headsets require the user to wear an apparatus. Speakerphones broadcast received audio so that others in the vicinity of the user can hear the received audio. Public address speaker systems can be heard by anyone in the vicinity even when an announcement is intended for only a single listener.

### BRIEF DESCRIPTION OF THE DRAWINGS

The above needs are at least partially met through provision of the method and apparatus to facilitate conveying audio content described in the following detailed description, particularly when studied in conjunction with the drawings, wherein:

FIG. 1 is a block diagram of a system according to an embodiment of the invention; and

FIG. 2 is a schematic diagram of a method according to an embodiment of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

An apparatus to facilitate conveying audio content and a related method are provided. The apparatus generally comprises a detector for determining a direction to a target, an audio emitter having a preferred directional output, and an audio receiver having a preferred directional sensitivity. The audio emitter and receiver are responsive to the directional information from the detector to maintain the target within their preferred directions.

These teachings provide for audio communication without requiring the target recipient to carry or wear any apparatus such as a handset or headset. These teachings further provide a capability for enhanced privacy relative to commonly used audio communication systems.

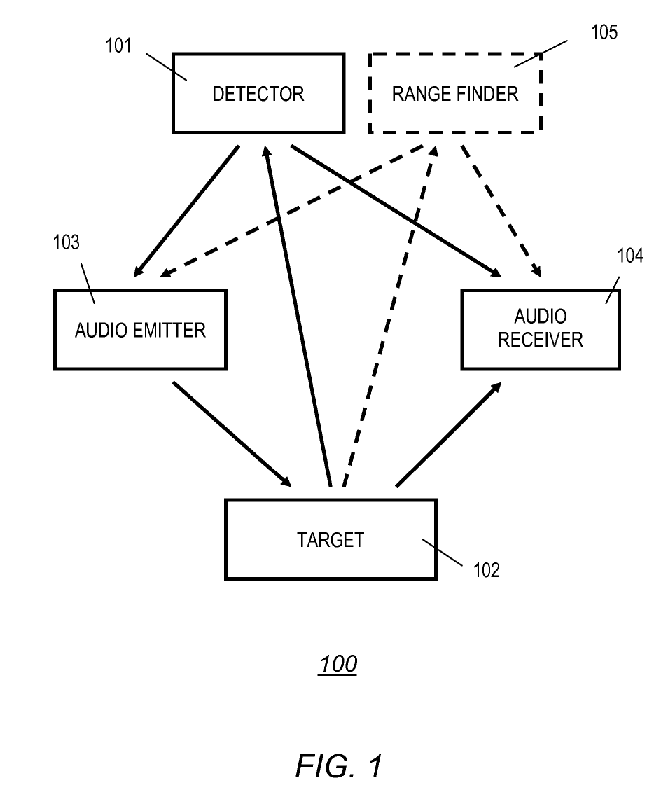

FIG. 1 depicts an apparatus 100 in accordance with some embodiments of the present invention. A detector 101 automatically determines directional information relative to a target 102. The target 102 will typically be a user of the apparatus 100 though this can vary with respect to the needs or requirements of a given application setting.

A wide variety of types of detectors 101 are possible. For example, the detector 101 could comprise a video detector coupled with a processor running computer vision algorithms to track the approximate direction to the target 102. As another example, the target 102 could be tracked ultrasonically. Other examples include passive infrared tracking and radio tracking. Those skilled in the art will readily recognize other options for determining directional information relative to a target. As such platforms and their manner of operation are known in the art, and further as these teachings are not particularly sensitive to the selection of any particular approach in this regard, for the sake of brevity additional elaboration regarding such platforms will not be provided here.

An aimable audio emitter 103 provides for the conveyance of audio communication to the target 102. The audio emitter 103 should have a preferred directional output that is selectively aimable so that an audio beam can be directed primarily to the target 102 while minimizing (or at least reducing) audio output in directions other than to the target 102. Examples of audio emitters 103 with a preferred directional output are known in the art. For example, it is known to form a beam of sound focused in a desired direction using an array of cooperating speakers coupled with appropriate signal processing. As another example, an ultrasonic heterodyne emitter takes advantage of certain nonlinear properties of air to produce a highly directional sound beam. As yet another example, a sound dome (that is, a specially configured reflecting surface) can be used to localize or focus sound waves. As these teachings are not particularly reliant upon the selection and use of any given approach in this regard, again for the sake of brevity additional details regarding such aimable audio emitters will not be presented here.

Because the aimable audio emitter 103 has a preferred directional output, it can provide enhanced communications privacy relative to conventional audio emitters. For example, with a conventional speakerphone, passers-by can overhear audio transmissions intended solely for the user of the speakerphone. With a focused audio beam, however, such transmissions can be more private as potential listeners other than the target will receive, at most, an audio signal having a considerably reduced corresponding volume. Additionally, audio beams focused on and directed to the intended target 102 should cause less disruption to others in the vicinity of the target 102 for these same reasons.

In some embodiments the audio emitter 103 is continuously (or substantially continuously) aimed according to information determined by the detector 101 so that the preferred directional output of the audio emitter 103 remains oriented toward the target 102 so long as the target 102 remains within range of the apparatus. This, in turn, allows some freedom of movement for the target 102.

An aimable audio receiver 104 provides for receiving audio communication that originates from the target 102. By one approach the audio receiver 104 may have a preferred directional sensitivity so that the receiver can selectively receive transmissions from the target 102 without also receiving too much (or at least as much) ambient noise as compared to a more omnidirectional approach to audio reception.

Additionally, directional sensitivity may allow the target to transmit their audio at a lower volume level than would be possible without directional sensitivity. Examples of audio receivers 104 with preferred directional sensitivity are known in the art. For example, directional microphones are well known and include hypercardioid or shotgun microphones and microphones equipped with parabolic reflectors. An array of cooperating microphones in conjunction with appropriate signal processing capability can also provide an audio receiver 104 with a preferred directional sensitivity. Again, these teachings may be used with any such receiving platforms. Accordingly, for the sake of brevity, additional details regarding such devices will not be provided here.

In some embodiments the audio emitter 103 and the audio receiver 104 are aimed so as to maintain the target 102 within the respective preferred directional sensitivity of the audio emitter 103 and the audio receiver 104. Depending on the configuration of a given emitter 103 or receiver 104, this aiming may be done mechanically and/or electronically as desired. For example, the emitter 103 or receiver 104 may be mechanically reoriented in response to directional information from the detector 101. Alternatively, some forms of audio emitter 103 or audio receiver 104 can be aimed electronically, for example by altering the signal processing used on received or generated audio transmissions.

In some embodiments, a range finder 105 may be added to the system described above. The range finder 105 may be used to determine an approximate distance to the target 102. The distance information may be used to further enhance the focus of the audio emitter 103 or the audio receiver 104.

In some embodiments, the detector 101 may be configured to track a plurality of targets 102 and the audio emitter 103 may be configured to provide individualized directional audio transmissions to at least some of the plurality of tracked targets 102. For example, the audio emitter 103 might comprise a plurality of independent speaker arrays, each having a preferred directional output. As another example, the emitter 103 might comprise a single speaker array together with appropriate signal processing capability to generate a plurality of audio streams each having a preferred directional output. Such configurations would enable, for example, the transmission of stereo audio to a user by conveying different audio transmissions to each of the user's ears.

In some embodiments, the detector 101 may be configured to track a plurality of targets 102 and the audio receiver 104 may be configured to receive separate audio transmissions from at least some of the tracked targets 102. For example, the audio receiver 104 might comprise a plurality of directional microphones, each receiving a separate audio transmission from a different target 102. As another example, the audio receiver 104 might comprise a microphone array together with appropriate signal processing capability to receive separate audio transmissions from the plurality of targets 102.

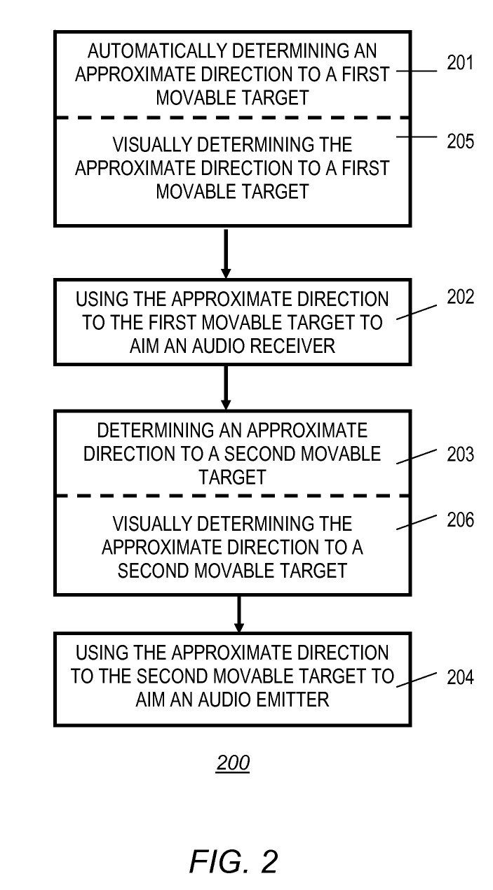

The teachings herein may also be understood to provide a method 200 for providing two-way audio communication, as depicted in FIG. 2. The approximate direction to a first movable target is automatically determined 201 and the resultant direction information is then used to aim an audio receiver having a preferred directional sensitivity so as to track the first movable target 202. Additionally, an approximate direction to a second movable target is determined 203 and the direction information is used to aim an audio emitter having a preferred directional output so as to track the second movable target 204.

In one common usage of the method, the first movable target may be a talking person. The second movable target may be a listening person. The two targets may be the same person or could be two different persons. In some applications, the first movable target could be the mouth of a user and the second movable target could be an ear of the user. In one embodiment of the method, the approximate directions to the two targets are determined visually 205 and 206.

One application for the apparatus and method described herein is a more natural form of telephony. A user essentially merely speaks into the air. These teachings facilitate tracking the user, receiving his or her voice transmissions, and beaming received voice transmissions directly to the user's ear or head. There is no handset or headset for the user to carry or wear and the user's conversation can be more private than possible with conventional speakerphones. Those skilled in the art will appreciate that these advantages accrue notwithstanding that the user is free to move about within the range of the system.

Other illustrative applications include personalized audio, such as in a home, office, outdoor, or vehicular environment; personalized sound cancellation without the need for headphones; personalized public address paging in public environments such as hospitals or theaters; and two-way audio communication with an individual within a crowd. Those skilled in the art will readily recognize various other applications.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

1. An apparatus comprising:
a detector for automatically tracking a direction to a target;
an aimable audio emitter responsive to the detector and having a preferred directional output; and
an aimable audio receiver responsive to the detector and having a preferred directional sensitivity.

2. The apparatus of claim 1 wherein the target comprises a user.

3. The apparatus of claim 1 wherein the detector comprises a vision-based detector.

4. The apparatus of claim 3 further comprising a range finder for determining an approximate distance between the detector and the target and wherein at least one of the aimable audio emitter and the aimable audio receiver is responsive to the range finder.

5. The apparatus of claim 1 wherein the aimable audio emitter is configured to provide a plurality of audio transmissions with at least some of the audio transmissions having preferred directional outputs.

6. The apparatus of claim 1 wherein the aimable audio receiver is configured to have a plurality of preferred directional sensitivities and to receive a plurality of audio transmissions.

7. The apparatus of claim 1 wherein the aimable audio emitter is selected from a group comprising:
a speaker array;
an ultrasonic heterodyne emitter; and
a sound dome.

8. The apparatus of claim 1 wherein the aimable audio receiver is selected from a group comprising:
a directional microphone;
a microphone array.

9. The apparatus of claim 1 wherein the aimable audio emitter is electronically aimable.

10. The apparatus of claim 1 wherein the aimable audio emitter is mechanically aimable.

11. The apparatus of claim 1 wherein the aimable audio emitter comprises means for producing a sound output having a preferred directional orientation.

12. The apparatus of claim 1 wherein the aimable audio receiver comprises means for determining the direction to a target for receiving a sound input and having a preferred directional sensitivity.

13. An apparatus comprising:
means for automatically determining a direction to a target;
aimable means responsive to the means for determining a direction to a target for producing a sound output having a preferred directional orientation; and
aimable means responsive to the means for determining a direction to a target for receiving a sound input and having a preferred directional sensitivity.

14. A method comprising:
automatically determining an approximate direction to a first movable target;
using the approximate direction to the first movable target to aim an audio receiver having a preferred directional sensitivity to track the first movable target;
determining an approximate direction to a second movable target;
using the approximate direction to the second movable target to aim an audio emitter having a preferred directional output to track the second movable target.

15. The method of claim 14 wherein the first movable target comprises a talking person.

16. The method of claim 14 wherein the second movable target comprises a listening person.

17. The method of claim 14 wherein the first movable target comprises a mouth of a user and the second movable target comprises an ear of the user.

18. The method of claim 14 wherein:
automatically determining an approximate direction to a first movable target comprises visually determining the approximate direction to the first movable target; and
determining an approximate direction to a second movable target comprises visually determining the approximate direction to the second movable target.
